(19) United States
(12) Patent Application Publication
(10) Pub. No.: US 2003/0210510 A1
(43) Pub. Date: Nov. 13, 2003

(54) Dynamic dechucking

(76) Inventors: Thomas C. Hann JR., Vancouver, WA (US); Jeffrey S. Zola, Portland, OR (US); Rennie G. Barber, Gresham, OR (US)

Correspondence Address: LSI LOGIC CORPORATION, 1621 BARBER LANE, MS: D-106 LEGAL, MILPITAS, CA, 95035, US

(21) Appl. No.: 10/140,838

(22) Filed: May 7, 2002

(51) Int. Cl. H01H 1/00

(52) U.S. Cl. 361/234

(57) ABSTRACT

An electrostatic substrate chucking system of the type having an electrostatic chuck for selectively retaining and selectively releasing a substrate. At least one sensor senses at least one parameter that is related to a degree to which electrostatic forces between the electrostatic chuck and the substrate have dissipated. Signals based on the at least one sensed parameter are sent from the sensor to a controller, which receives the signals and determines whether the electrostatic forces between the electrostatic chuck and the substrate have sufficiently dissipated so as to safely remove the substrate from the electrostatic chuck.

### FIELD

This invention relates to the field of substrate retention systems. More particularly, this invention relates to electrostatic substrate dechucking in semiconductor substrate processing, and using feedback to determine when the substrate may be safely dechucked.

### BACKGROUND

There are many processes in which the substrate on which semiconductor devices are formed is held in place by gravity alone. In such processes, the substrate is typically held in a horizontal face up position, which tends to be the only orientation available when gravity alone is used to hold the substrate. However, it is often desirable to retain the substrate in an alternate position during processing. In addition, there may be reasons for wanting to retain the substrate in a horizontal position. For example, the process may be one in which the substrate tends to be moved about, such as by the forces of moving fluids. Further, it may be desired to subject the substrate to a process condition that impinges upon the substrate from a very specific angle. Thus, retaining the substrate in a specific orientation during a process such as these improves the process by reducing variability, such as might be introduced by substrates that are in different positions from run to run.

Generally, two different forms of substrate retention are used. In one form, the substrate is mechanically held against a support means, such as a backing plate. Various means, such as clips, springs, or rings, are used to make contact with the front of the substrate and to press against the front of the substrate so as to retain the substrate against the support means. While retaining the substrate using front side contact is a very easily implemented method of retaining the substrate, it unfortunately tends to introduce certain undesirable conditions. There are a variety of reasons for this.

For example, physical clamping systems tend to general particulate matter, which contacts the surface of the substrates on which the integrated circuits are formed and thereby reduces the yield of the process. In addition, contact with the front side of the substrate tends to increase the likelihood of damage to the devices, such as by physically scratching or otherwise crushing or damaging the devices contacted by the front side contact means.

Further, contact on the front side of the substrate during certain steps tends to mask the substrate, in the region of the clips or springs that are used to retain the substrate, from the desired processing that is accomplished while the substrate is retained. For example, the clip that makes contact with the front side of the substrate to hold the substrate against a backing plate tends to partially mask the substrate during a deposition process. By masking the desired processing in various locations on the substrate, the devices to be formed in those locations do not receive the processing that is necessary to function properly. Thus, substrate yield is somewhat reduced and cost is commensurately increased.

For the reasons given above, retaining the substrate by means that contact only the back side of the substrate tend to be preferred in many applications. Unfortunately, there are other issues associated with the back side contact methods used to retain substrates. For example, retaining a substrate by drawing a vacuum against the back side of the substrate is only practical at certain processing pressures. Since a vacuum can only be drawn to a theoretical limit of a pressure of zero, processing which is performed under very low pressure conditions tends to reduce the total amount of force that retains the substrate in place. Thus, as the processing pressure is reduced, there is an increased tendency for substrates to work loose from the retaining means. This, of course, tends to reduce the effectiveness of the substrate retention means.

Another method of retaining substrates using back side contact is an electrostatic chuck. This method works by inducing regional electrostatic charges in the substrate with the electrostatic chuck, and then attracting these regional electrostatic charges with opposing complimentary charges in the electrostatic chuck. The attraction between the opposing complimentary charges in the electrostatic chuck and the induced regional electrostatic charges in the substrate tend to retain the substrate against the electrostatic chuck.

Dechucking a substrate from an electrostatic chuck tends to have problems associated with it. For example, when releasing the substrate from the chuck, a variable length of time is required for the regional static charges to recombine and dissipate, allowing the substrate to be smoothly released from the chuck without a lingering attraction between the chuck and the substrate. Because this time period is variable, automated equipment, such as robotic substrate handlers, often attempt to remove the substrate from the chuck before the charges have dissipated, when there is still an electrostatic attraction between the substrate and the chuck. This results in a variety of problems, such as substrates popping free from the chuck and become dislodged or damaged. Damage to the robotic equipment or the processing equipment also tends to occur. Removing the substrate from the chuck without having problems such as these is generally referred to herein as safely removing the substrate from the chuck.

What is needed, therefore, is a system for determining when the electrostatic charges have sufficiently dissipated from the substrate so that it can be safely released from the electrostatic chuck.

### SUMMARY

The above and other needs are met by an electrostatic substrate chucking system of the type having an electrostatic chuck for selectively retaining and selectively releasing a substrate. At least one sensor senses at least one parameter that is related to a degree to which electrostatic forces between the electrostatic chuck and the substrate have dissipated. Signals based on the at least one sensed parameter are sent from the sensor to a controller, which receives the signals and determines whether the electrostatic forces between the electrostatic chuck and the substrate have sufficiently dissipated so as to safely remove the substrate from the electrostatic chuck.

In this manner, the substrate is removed from the electrostatic chuck at a point in time when sensed parameters relating to the degree of remaining electrostatic forces between the substrate and the electrostatic chuck indicate that the substrate may be safely removed from the electrostatic chuck, rather than merely waiting for a predetermined amount of time. In other words, a feedback system is used to determine when to remove the substrate, rather than using a timer to determine when to remove the substrate.

In various preferred embodiments of the invention, the at least one sensor is a flow rate sensor and the at least one parameter is a flow rate of a backside coolant flowing through the electrostatic chuck. The controller is operable to determine when the flow rate of the backside coolant reaches a level that indicates that the electrostatic forces between the electrostatic chuck and the substrate have sufficiently dissipated. This is preferably based on historical data that correlates the flow rate of the backside coolant with the degree to which electrostatic forces between the electrostatic chuck and the substrate have dissipated. Other sensors and other parameters may also be used.

### BRIEF DESCRIPTION OF THE DRAWINGS

Further advantages of the invention are apparent by reference to the detailed description when considered in conjunction with the figures, which are not to scale so as to more clearly show the details, wherein like reference numbers indicate like elements throughout the several views, and wherein:

FIG. 1 is a cross sectional functional representation of an electrostatic chuck prior to energizing,

FIG. 2 is a cross sectional functional representation of the electrostatic chuck during energizing, and

FIG. 3 is a cross sectional functional representation of the electrostatic chuck with sensors and a controller according to a preferred embodiment of the present invention.

### DETAILED DESCRIPTION

Referring now to FIG. 1, there is depicted a cross sectional functional representation of an electrostatic chuck 10, upon which resides a substrate 12. The electrostatic chuck 10 has an electrically nonconductive portion 14 formed of a relatively electrically nonconductive material, such as a ceramic or a thermoplastic resin, and a portion 20 that may have a variety of functions, as described more completely below, and which may be formed of either an electrically nonconductive material or an electrically conductive material.

Buried within the nonconductive portion 14 are a first electrical conductor 16 and a second electrical conductor 18. The first conductor 16 and the second conductor 18 are preferably formed of a relatively electrically conductive material, such as a metal or a metal alloy. The first conductor 16 is connected to one pole of a power supply 26 via electrically conductive path 22, and the second conductor 18 is connected to the other pole of the power supply 26 via electrically conductive path 24. The conductive path 22 and the conductive path 24 are preferably formed of a relatively electrically conductive material, such as insulated metal wires.

One of the primary purposes of the nonconductive portion 14 is to insulate the substrate 12 from the first conductor 16 and the second conductor 18. Thus, the nonconductive portion 14 does not necessary entirely encase the first conductor 16 and the second conductor 18, but may alternately be a relatively planar piece disposed between the substrate 12 and the first and second conductors 16 and 18. Another function of the nonconductive portion 14 is to provide electrical insulation between the first conductor 16 and the second conductor 18, and between both the first conductor 16 and the second conductor 18 and the other portion 20 of the electrostatic chuck 10. However, these functions can be performed by elements other than the nonconductive portion 14.

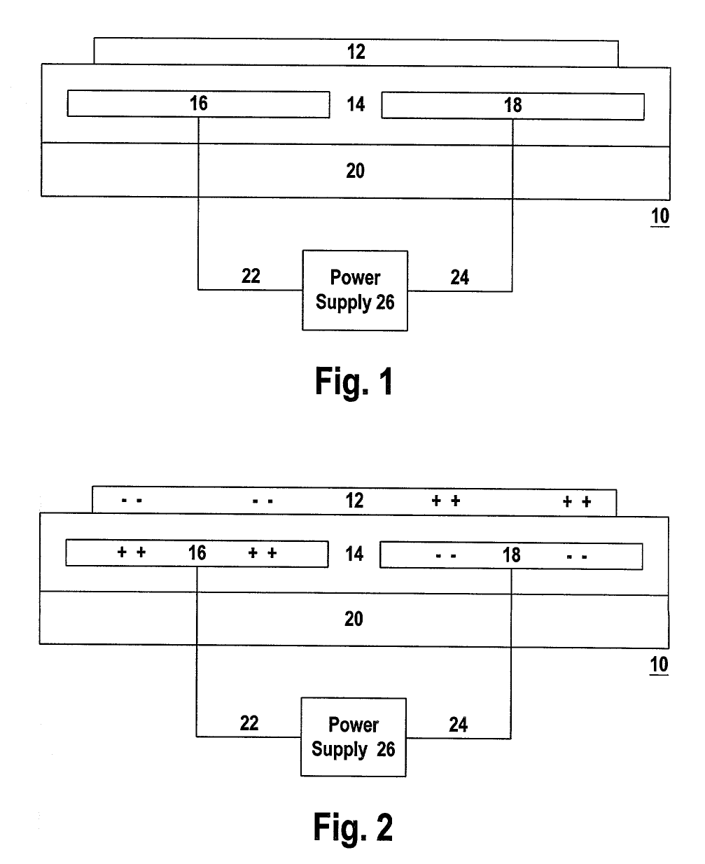

The electrostatic chuck 10 operates by energizing the power supply 26 to create a positive potential in one of the first conductor 16 and the second conductor 18 and a negative potential in the other of the first conductor 16 and the second conductor 18. For example, as depicted in FIG. 2, the power supply 26 is energized to create a positive potential in the first conductor 16 and a negative potential in the second conductor 18. By virtue of the non-electrically conductive properties of the nonconductive portion 14, the positive potential in the first conductor 16 and the negative potential in the second conductor 18 are not equalized by a flowing electrical current through the substrate 12. Thus, the positive electrical potential in the first conductor 16 and the negative electrical potential in the second conductor 18 are not dissipated, but remain within the first conductor 16 and the second conductor 18 to exert an influence on the substrate 12.

The influence exerted on the substrate 12 tends to induce regional electrical charges within the substrate 12. As depicted, the positive electrical potential in the first conductor 16 tends to induce a regional negative electrical charge within that portion of the substrate 12 that overlies the positively charged first conductor 16. This is accomplished because the positively charged first conductor tends to attract the opposite electrical charges, being the negative electrical charges, that are already within the substrate 12. Similarly the negative electrical potential in the second conductor 18 tends to induce a regional positive electrical charge within that portion of the substrate 12 that overlies the negatively charged second conductor 18. This is accomplished because the negatively charged second conductor tends to attract the opposite electrical charges, being the positive electrical charges, that are already within the substrate 12.

The electrostatic attraction between the regional negative electrical charges and the positively charged first conductor 16, combined with the electrostatic attraction between the regional positive electrical charges and the negatively charge second conductor 18, tend to produce a force by which the substrate 12 is retained against the electrostatic chuck 10. In this manner, energizing the power supply 26 produces gripping signals that enable the retention of the substrate 12 against the electrostatic chuck 10, and de-energizing the power supply 26 enables the release of the substrate 12 from the electrostatic chuck 10, which can be considered to be a release signal.

As depicted in the various figures herein, such as in FIG. 2, the electrostatic chuck 10 is depicted as having two electrodes, being a first conductor 16 and a second conductor 18. It is appreciated that this specific configuration is exemplary only, and is used for the sake of simplicity of the figures and ease in description of the operation of the electrostatic chuck 10. In actual construction, the electrostatic chuck 10 may have several positively charged electrodes, such as the first conductor 16, and several negatively charged electrodes, such as the second conductor 18. These various positive and negative electrodes may be disposed around the surface of the electrostatic chuck 10 according to one or more of a variety of different patterns. For example, the positive and negative electrodes may be interleaved, with positive electrodes disposed between each of the negative electrodes. Further, the positive and negative electrodes may be disposed in a checkerboard pattern of the positive and negative electrodes. Although a bipolar electrostatic chuck 10 is depicted in the figures, it is appreciated that other types of electrostatic chucks 10 are also comprehended herein, such as monopolar electrostatic chucks 10.

In addition, the sizes of the electrodes, relative to the size of the electrostatic chuck 10 or the substrate 12, may not be the same as that depicted in the figures. For example, the positive and negative electrodes may be relatively narrow in comparison to the width of the electrostatic chuck 10. Alternately, one set of the electrodes, for example the positive electrodes, may be relatively narrow, and the other set of electrodes, for example the negative electrodes, may be relatively wide. In further embodiments, various ones of either or both sets of the positive and negative electrodes may be relatively narrow, while others of either or both sets of the positive and negative electrodes may be relatively wide.

It is noted that, at the point to which an explanation of the system has currently been made, the substrate 12 tends to have a substantial balance between the amount of negative charges regionally disposed in the portion of the substrate 12 that overlies the first conductor 16 and the amount of positive charges regionally disposed in the portion of the substrate 12 that overlies the second conductor 18. Thus, if the power supply 26 is de-energized at this point, the regional positive charge and the regional negative charge would both tend to dissipate, as the charges recombined and equalized throughout the substrate 12. Thus, as the regional positive and negative charges dissipated, the electrostatic forces by which the substrate 12 is held to the electrostatic chuck 10 are also dissipated, and the substrate 12 is freely removed from the electrostatic chuck 10.

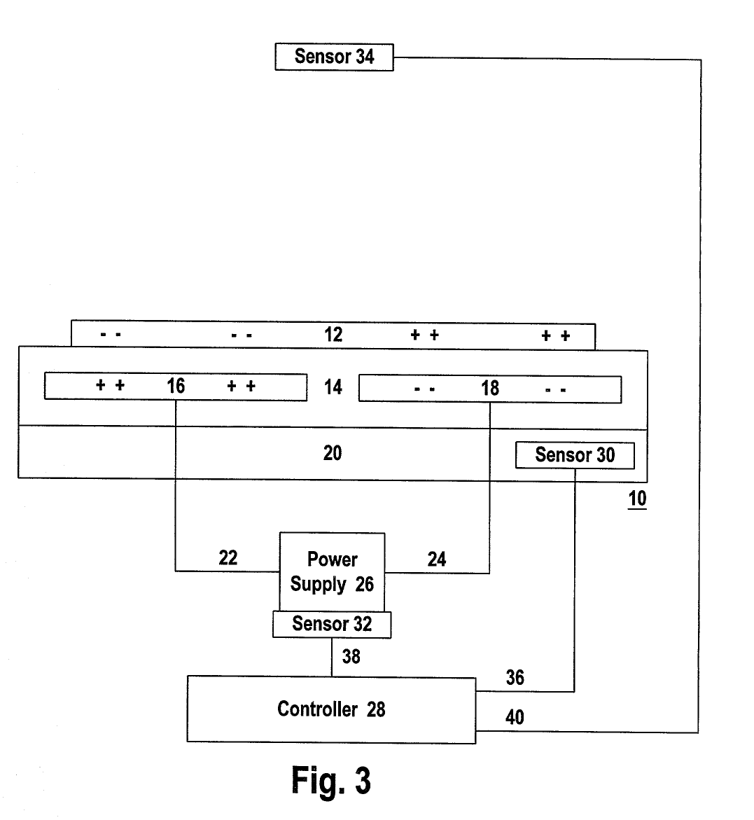

However, as mentioned above, there are a variety of conditions that tend to make the length of time required for the sufficient dissipation of the electrostatic charges quite variable, and often it is not sufficient to merely allow a predetermined amount of time for such dissipation of the electrostatic charges. Thus, according to the present invention there is provided a controller 28 that receives signals from sensors such as 30, 32, and 34 as depicted in FIG. 3, which sensors 30, 32, and 34 detect conditions that are effected at least in part by the degree to which the electrostatic attraction between the substrate 12 and the electrostatic chuck 10 has dissipated.

Most preferably, the signals from the sensors 30, 32, and 34 are used in a feedback loop by the controller 28, which prohibits the removal of the substrate 12 from the electrostatic chuck 10 prior to receiving signals that indicate that the electrostatic attraction has sufficiently dissipated, and permits the removal of the substrate 12 from the electrostatic chuck 10 after receiving signals that indicate that the electrostatic attraction has sufficiently dissipate. The sensors 30, 32, and 34 preferably report their signals to the controller 28 such as by lines 36, 38, and 40, respectively.

For example, the sensor 30 is placed within portion 20, which in the example as depicted is a backside cooling chamber of the electrostatic chuck 10, and senses the flow rate of a backside cooling fluid, such as a gas, as the electrostatic forces dissipate. It has been discovered that the flow rate of such gases tends to increase as the electrostatic forces dissipate. In addition, as the electrostatic forces between the substrate 12 and the electrostatic chuck 10 decrease, backside cooling gas tends to be released into the processing chamber to some degree. This can be detected in some systems with a sensor 34, such as would detect a spike in a type of plasma. Further, the power supply 26 providing power to the electrostatic chuck 10 can be monitored for parameters such as bias voltage and supply current by sensor 32. This information can be historically tracked to correlate it with when the substrate 12 may be safely dechucked from the electrostatic chuck 10.

Thus, according to the present invention, the substrate 12 is removed from the electrostatic chuck 10 at a point in time when feedback conditions as determined by sensors 30, 32, and 34 indicate that the electrostatic forces between the substrate 12 and the electrostatic chuck 10 have sufficiently dissipated, rather than merely waiting for a predetermined amount of time in the hope that such amount of time is sufficient for the electrostatic forces to dissipate.

In alternate embodiments of the invention, the sensors 30, 32, and 34 measure parameters that may not be directly influenced by the electrostatic forces between the substrate 12 and the electrostatic chuck 10, but rather sense a variable that indicates whether electrostatic forces should have dissipated. For example, it may be empirically observed that the dissipation of electrostatic forces tracks the number of process runs that have occurred in a particular processing chamber since a major event, such as a clean. Alternately or additionally, other parameters such as the number of substrates that have been processed in the chamber or the total length of processing time that has elapsed since a prior major event can be tracked, such as the number of RF hours on a plasma chamber. Thus, the sensors can either determine this information and provide it to the controller 28, or the controller 28 can determine or receive this information in some other manner, such as by input from an operator

The different embodiments as described above may have different degrees of utility to different processes. For example, the technique that is preferred for one process may not be the preferred technique for another process. Thus, in some embodiments the system includes all sensors and data collection methods within the scope of those exemplified herein, but only uses those sensors and data collection methods which are applicable to the process in which the system is used. In alternate embodiments the system includes only those sensors and data collection methods which are applicable to the process in which the system is used.

The foregoing embodiments of this invention have been presented for purposes of illustration and description. They are not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as is suited to the particular use contemplated. All such modifications and variations are within the scope of the invention as determined by the appended claims when interpreted in accordance with the breadth to which they are fairly, legally, and equitably entitled.

What is claimed is:

1. In an electrostatic substrate chucking system of the type having an electrostatic chuck for selectively retaining and selectively releasing a substrate, the improvement comprising:
at least one sensor for sensing at least one parameter related to a degree to which electrostatic forces between the electrostatic chuck and the substrate have dissipated, and sending signals based on the at least one sensed parameter, and
a controller for receiving the signals and determining whether the electrostatic forces between the electrostatic chuck and the substrate have sufficiently dissipated so as to safely remove the substrate from the electrostatic chuck.

2. The electrostatic substrate chucking system of claim 1, wherein the controller is further operable to compare the signals to historical data to determine whether the electrostatic forces between the electrostatic chuck and the substrate have sufficiently dissipated so as to safely remove the substrate from the electrostatic chuck.

3. The electrostatic substrate chucking system of claim 1, wherein the controller is further operable to output a signal indicating that the electrostatic forces between the electrostatic chuck and the substrate have sufficiently dissipated so as to safely remove the substrate from the electrostatic chuck.

4. The electrostatic substrate chucking system of claim 1, wherein the at least one sensor is a flow rate sensor and the at least one parameter is a flow rate of a backside coolant flowing through the electrostatic chuck, and the controller is operable to determine when the flow rate of the backside coolant reaches a level that indicates that the electrostatic forces between the electrostatic chuck and the substrate have sufficiently dissipated, based on historical data that correlates the flow rate of the backside coolant with the degree to which electrostatic forces between the electrostatic chuck and the substrate have dissipated.

5. The electrostatic substrate chucking system of claim 1, wherein the at least one sensor is an optical sensor and the at least one parameter is an optical emission spike in a plasma used to process the substrate, and the controller is operable to determine when the optical emission spike reaches a level that indicates that the electrostatic forces between the electrostatic chuck and the substrate have sufficiently dissipated, based on historical data that correlates the optical emission spike with the degree to which electrostatic forces between the electrostatic chuck and the substrate have dissipated.

6. The electrostatic substrate chucking system of claim 1, wherein the at least one sensor is a voltage sensor and the at least one parameter is a bias voltage on the power supply used to power the electrostatic chuck, and the controller is operable to determine when the bias voltage reaches a level that indicates that the electrostatic forces between the electrostatic chuck and the substrate have sufficiently dissipated, based on historical data that correlates the bias voltage with the degree to which electrostatic forces between the electrostatic chuck and the substrate have dissipated.

7. The electrostatic substrate chucking system of claim 1, wherein the at least one sensor is a current sensor and the at least one parameter is a supply current on the power supply used to power the electrostatic chuck, and the controller is operable to determine when the supply current reaches a level that indicates that the electrostatic forces between the electrostatic chuck and the substrate have sufficiently dissipated, based on historical data that correlates the supply current with the degree to which electrostatic forces between the electrostatic chuck and the substrate have dissipated.

8. In a method of dechucking a substrate from an electrostatic chuck, the improvement comprising the steps of:
sensing with at least one sensor at least one parameter related to a degree to which electrostatic forces between the electrostatic chuck and the substrate have dissipated,
creating and sending signals based on the at least one sensed parameter,
receiving the signals with a controller,
comparing the signals received from the at least one sensor to at least one set point, and
determining whether the electrostatic forces between the electrostatic chuck and the substrate have sufficiently dissipated so as to safely remove the substrate from the electrostatic chuck, based upon the comparison.

9. The method of claim 8 wherein the at least one set point is based at least in part upon historically derived data.

10. The method of claim 8 further comprising the additional step of outputting a signal from the controller indicating that the electrostatic forces between the electrostatic chuck and the substrate have sufficiently dissipated so as to safely remove the substrate from the electrostatic chuck.

11. The method of claim 8 wherein the step of sensing at least one parameter related to a degree to which electrostatic forces between the electrostatic chuck and the substrate have dissipated comprises sensing a flow rate of a backside coolant flowing through the electrostatic chuck.

12. The method of claim 8 wherein the step of sensing at least one parameter related to a degree to which electrostatic forces between the electrostatic chuck and the substrate have dissipated comprises sensing an optical emission spike in a plasma used to process the substrate.

13. The method of claim 8 wherein the step of sensing at least one parameter related to a degree to which electrostatic forces between the electrostatic chuck and the substrate have dissipated comprises sensing a bias voltage on a power supply used to power the electrostatic chuck.

14. The method of claim 8 wherein the step of sensing at least one parameter related to a degree to which electrostatic forces between the electrostatic chuck and the substrate have dissipated comprises sensing a supply current on a power supply used to power the electrostatic chuck.

15. In a method of dechucking a substrate from an electrostatic chuck, the improvement comprising the steps of:
sensing with at least one sensor at least one parameter related to a degree to which electrostatic forces between the electrostatic chuck and the substrate have dissipated,
creating and sending signals based on the at least one sensed parameter,
receiving the signals with a controller,
comparing the signals received from the at least one sensor to at least one set point that is based at least in part upon historically derived data,
determining whether the electrostatic forces between the electrostatic chuck and the substrate have sufficiently dissipated so as to safely remove the substrate from the electrostatic chuck, based upon the comparison, and
outputting a signal from the controller indicating that the electrostatic forces between the electrostatic chuck and the substrate have sufficiently dissipated so as to safely remove the substrate from the electrostatic chuck.

16. The method of claim 15 further comprising the additional steps of:
receiving the signal from the controller with a robot arm, and
dechucking the substrate with the robotic arm.

17. The method of claim 15 wherein the step of sensing at least one parameter related to a degree to which electrostatic forces between the electrostatic chuck and the substrate have dissipated comprises sensing a flow rate of a backside coolant flowing through the electrostatic chuck.

18. The method of claim 15 wherein the step of sensing at least one parameter related to a degree to which electrostatic forces between the electrostatic chuck and the substrate have dissipated comprises sensing an optical emission spike in a plasma used to process the substrate.

19. The method of claim 15 wherein the step of sensing at least one parameter related to a degree to which electrostatic forces between the electrostatic chuck and the substrate have dissipated comprises sensing a bias voltage on a power supply used to power the electrostatic chuck

20. The method of claim 15 wherein the step of sensing at least one parameter related to a degree to which electrostatic forces between the electrostatic chuck and the substrate have dissipated comprises sensing a supply current on a power supply used to power the electrostatic chuck.
